(19) United States
(12) Patent Application Publication
(10) Pub. No.: US 2024/0270774 A1
(43) Pub. Date: Aug. 15, 2024

(54) NEW ORGANIC COMPOUND AND FLAME RETARDANT USING SAME

(71) Applicants: PANASONIC INTELLECTUAL PROPERTY MANAGEMENT CO., LTD., Osaka (JP); SANKO CO., LTD., Fukuoka (JP)

(72) Inventors: Hirosuke SAITO, Osaka (JP); Hiroshi SUMITOMO, Osaka (JP)

(73) Assignees: PANASONIC INTELLECTUAL PROPERTY MANAGEMENT CO., LTD., Osaka (JP); SANKO CO., LTD., Fukuoka (JP)

(21) Appl. No.: 18/289,953

(22) PCT Filed: May 12, 2022
(86) PCT No.: PCT/JP2022/020112

§ 371 Date: Nov. 8, 2023

(30) Foreign Application Priority Data
May 13, 2021 (JP) 2021-081740

(51) Int. Cl. C07F 9/6571; C08K 5/5313

(52) U.S. Cl. CPC C07F 9/657172; C08K 5/5313

(57) ABSTRACT

An organic compound is represented by the following formula (1).

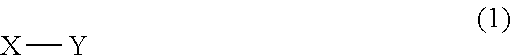

wherein X is 9,10-dihydro-9-oxa-10-phosphaphenanthrene-10-yl-10-oxide and Y is a protecting group.

### TECHNICAL FIELD

The present invention relates to a novel organic compound and a flame retardant using the same.

### BACKGROUND ART

Hitherto, an organic halogen compound typified by decabromodiphenyl ether and a brominated epoxy resin has been widely applied as a flame retardant of a synthetic resin because of its excellent flame retardant effect, ease of application, low price, and the like.

However, it is recently considered to be problematic that a gas harmful to humans is generated and a toxic substance significantly affecting the natural environment is produced as a by-product at the time when a synthetic resin added with an organic halogen compound is combusted.

Therefore, there is active movement of attempting to switch the organohalogen compound to another flame retardant, however, this movement cannot be said to be smooth except for synthetic resins such as phenol resins, polycarbonate resins, and epoxy resins, which are relatively easily made flame retardant.

The reason for this is that other flame retardants do not effectively work on compared to organohalogen compounds in application to many synthetic resins and flame retardant processing. For example, flame retardancy provided with an organophosphorus compound is generally considered based on the promotion effects of the carbonization of a synthetic resin to turn the surface thereof into a char layer during combustion thereby shielding thermal energy of an ignition source or shielding air required for combustion. Therefore, every synthetic resin which is easily made flame-resistant with the organophosphorus compound is limited to a resin on which a char layer is easily formed during its combustion.

On the other hand, the flame retardant mechanism of an organohalogen compound is considered to be a flame extinguishing effect caused by stable halogen radicals generated at the time of combustion, and there are some reports referring to the same fire extinguishing action.

Patent Document 1 and Patent Document 2 describe combined use of an organophosphorus compound and 2,3-dimethyl-2,3-diphenylbutane, and Patent Document 3 describes combined use of an organohalogen compound and 2,3-dimethyl-2,3-diphenylbutane, and both state contribution of the halogen radical generation during combustion to flame retardancy.

Patent Document 4 describes organic peroxides having a high decomposition temperature, such as dicumyl peroxide and cumene hydroperoxide, as flame retardant aids for foamed polystyrene, and implies contribution of radical generation during combustion thereof to flame retardancy

In addition, Non-Patent Document 1 describes a specific flame retardant effect of a 9,10-dihydro-9-oxa-10-phosphaphenanthrene-10-oxide derivative as a phosphorus compound. Furthermore, this document also described a flame extinguishing effect by radical generation that cannot be found in typical organophosphorus compounds, namely, by 9,10-dihydro-9-oxa-10-phosphaphenanthrene-10-ylradical-10-oxide.

As matters now stand, however, there are very few reports or practical examples of flame retardants containing no halogen atom capable of imparting flame retardancy to non-charring resins, apart from organic halogen compounds.

The present invention is made in view of such circumstances, and an object the present invention is to provide a novel organic compound which does not contain a halogen atom, is excellent in both flame retardancy and heat resistance, and can be used as a flame retardant for a resin.

### CITATION LIST

### Patent Literatures

Patent Document 1: JP 2003-34749 A
Patent Document 2: JP 2004-115763 A
Patent Document 3: JP 2000-1563 A
Patent Document 4: JP H111-130898 A

### Non Patent Literature

Non-Patent Document 1: Sen'i Gakkaishi (Journal of the Society of Fiber Science and Technology, Japan), Vol. 62, No. 10 (2006).

### SUMMARY OF INVENTION

The organic compound according to an embodiment of the present invention is represented by the following formula (1).

X—Y (1)
wherein X is 9,10-dihydro-9-oxa-10-phosphaphenanthrene-10-yl-10-oxide and Y is a protecting group.

### BRIEF DESCRIPTION OF DRAWINGS

FIG. 1 is an infrared absorption spectrum (IR) of an organic compound 1 obtained in Production Example 1.

FIG. 2 is a 1H-NMR spectrogram of an organic compound 1 obtained in Production Example 1.

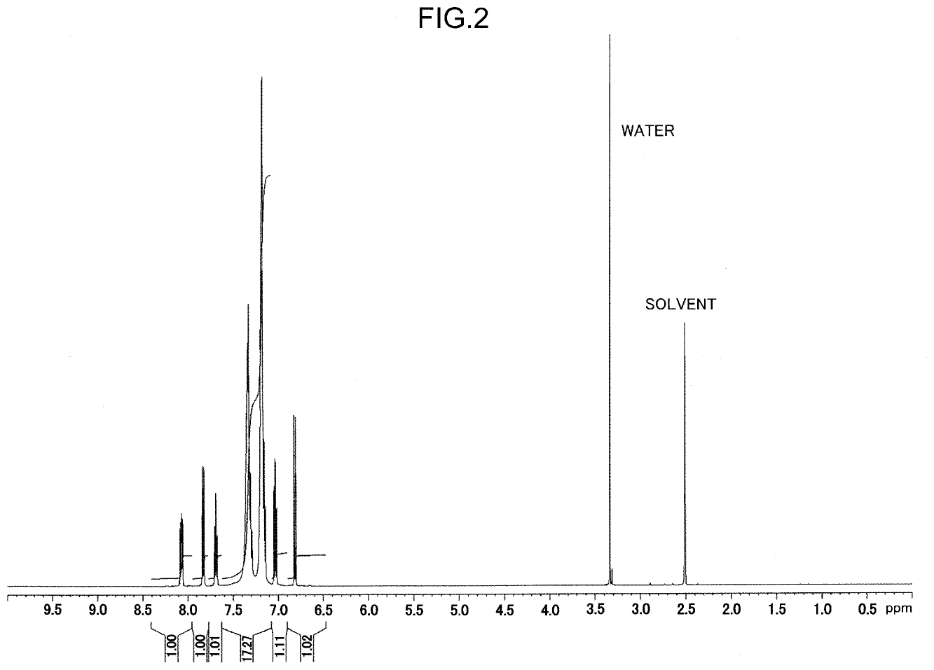

FIG. 3 is an FD-MS of an organic compound 1 obtained in Production Example 1.

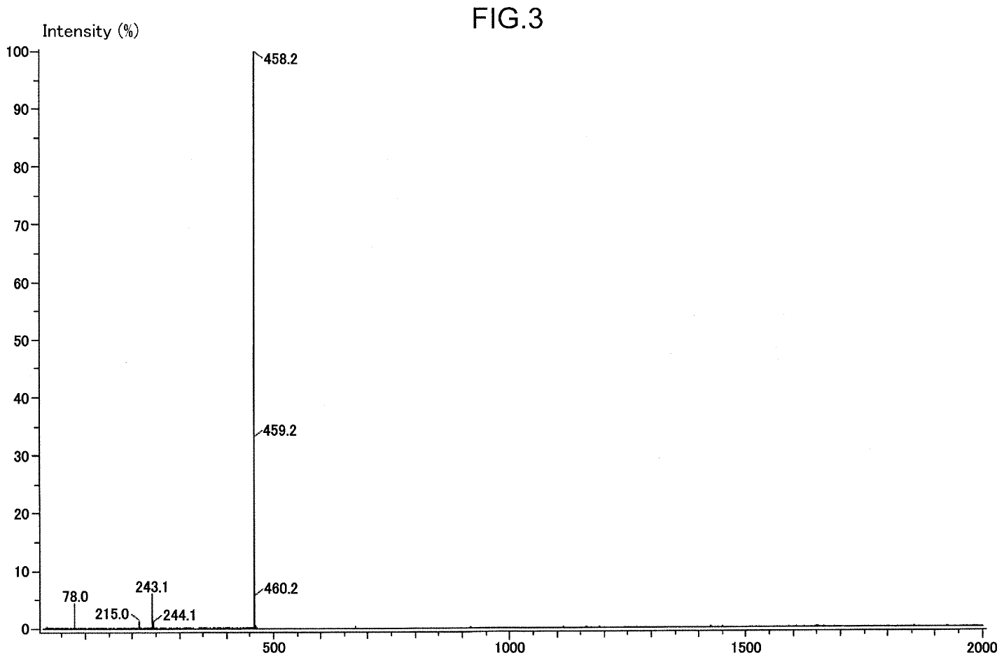

FIG. 4 is an infrared absorption spectrum (IR) of an organic compound 2 obtained in Production Example 2.

FIG. 5 is a 1H-NMR spectrogram of an organic compound 2 obtained in Production Example 2.

FIG. 6 is an FD-MS spectrogram of an organic compound 2 obtained in Production Example 2.

FIG. 7 is an infrared (IR) absorption spectrum of an organic compound 3 obtained in Production Example 3.

FIG. 8 is an infrared (IR) absorption spectrum of an organic compound 4 obtained in Production Example 4.

FIG. 9 is an FD-MS spectrogram of an organic compound 4 obtained in Production Example 4.

FIG. 10 is an infrared (IR) absorption spectrum of an organic compound 5 obtained in Production Example 5.

FIG. 11 is an FD-MS spectrogram of an organic compound 5 obtained in Production Example 5.

### DESCRIPTION OF EMBODIMENTS

### Organic Compound

The organic compound according to the present embodiment is represented by the following formula (1).

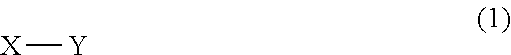

In the formula (1), X is 9,10-dihydro-9-oxa-10-phosphaphenanthrene-10-yl-10-oxide. Y represents a protecting group.

According to the above configuration, it is possible to provide a novel organic compound which does not contain a halogen atom, is excellent in both flame retardancy and heat resistance, and can be used as a flame retardant for resins.

The organic compound of the present embodiment is very excellent in thermal stability and flame retardancy in spite of containing no halogen atom. This is considered to be due to the fire extinguishing effect by stable radicals generated by uniform cleavage of the compound during combustion. The mechanism is not completely clear, but is considered to be approximately as follows.

That is, in the compound, the radical atom of X generated by liberation of Y as a protecting group undergoes resonance stabilization with at least one adjacent aromatic ring, and hence cleavage into a radical proceeds very smoothly, and the generated radical is considered to be stable. Therefore, the organic compound of the present embodiment can be suitably used as a flame retardant.

In the compound, the protecting group Y refers to a substituent that is temporarily introduced to inactivate reactivity on the premise that a specific functional group of a compound having a functional group is eliminated at a later stage, and this enhances the chemical stability of the compound. The later stage in the present embodiment refers to the time of combustion of the resin composition containing the compound.

The protecting group used in the present embodiment has no particular problem as long as it is a protecting group introduced by a protecting reagent. As such a protective reagent, a protective reagent derived from a generally available (e.g., commercially available) or synthesizable protective reagent can be used.

Specifically, examples of the protecting group Y include: silyl group, acyl group, allyl group, allyloxycarbonyl group, benzyl group, benzyloxycarbonyl group, acetal group, thioacetal group, 2,2,2-trichloroethoxycarbonyl group, alkoxymethyl group, tert-butoxycarbonyl group, 9-fluorenylmethyloxycarbonyl group, trityl group, and sulfonyl group. In particular, among these groups, the group is preferable such that the total molecular weight of the compound of the formula (1) is 250 or more, and when the bond between X and Y is cleaved, as with the radical atom of X, the radical atom of Y is also a group is stabilized by resonance with at least one adjacent aromatic ring to easily generate a stable radical.

Furthermore, the protecting group Y is preferably a group represented by the following formula (2).

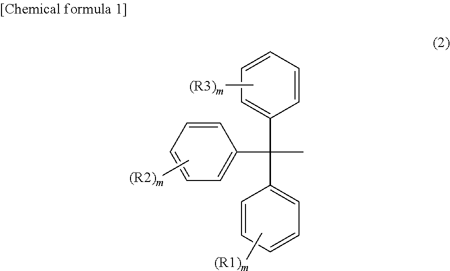

In the formula (2), R1, R2, and R3 each independently represent hydrogen, a benzoyloxy group, a vinylbenzyl group, an alkoxy group having 1 to 6 carbon atoms, or an alkenyl group having 2 to 6 carbon atoms, and m each independently represents an integer from 1 to 5.

In the organic compound represented by the formula (1), when the protecting group Y is a group represented by the formula (2), each radical atom generated by cleavage of the organic compound undergoes resonance stabilization with at least one aromatic ring on one side (X side) and three aromatic rings on the other side (protecting group Y side), and therefore cleavage into a radical pair is considered to proceed more smoothly. Therefore, the above-described flame retardant effect can be more reliably exhibited.

More specific examples of the group represented by the formula (2) include a trityl group, a 4-methoxytrityl group, a 4,4′-dimethoxytrityl group, and a 4,4′,4″-tris(benzoyloxy)trityl group.

For example, when the protecting group Y is a trityl group, the organic compound of the present embodiment is as follows (provided that, compounds (1-2) to (1-4) other than compound (1-1) are reference compounds.):

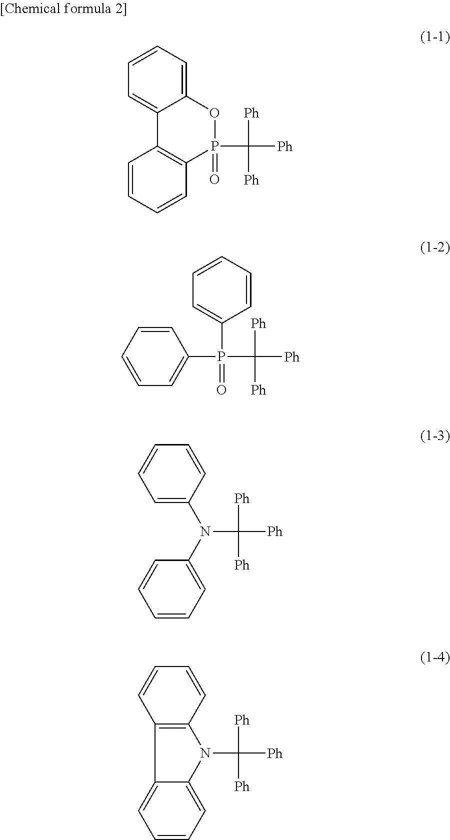 [SMILES: O=P1(C(c2ccccc2)(c2ccccc2)c2ccccc2)Oc2ccccc2-c2ccccc21 ; O=P(c1ccccc1)(c1ccccc1)C(c1ccccc1)(c1ccccc1)c1ccccc1 ; c1ccc(N(c2ccccc2)C(c2ccccc2)(c2ccccc2)c2ccccc2)cc1 ; c1ccc(C(c2ccccc2)(c2ccccc2)n2c3ccccc3c3ccccc32)cc1]

For example, when the protecting group Y is a 4-methoxytrityl group, the organic compound of the present embodiment is as follows (provided that, compounds (2-2) to (2-4) other than compound (2-1) are reference compounds.):

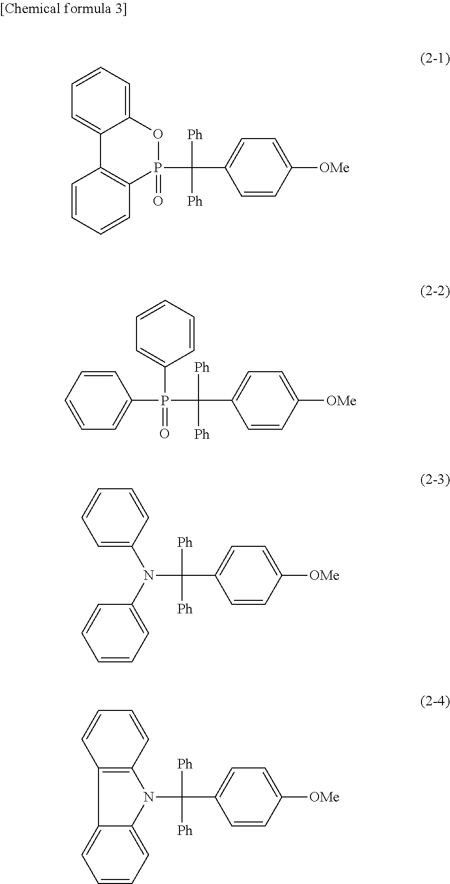 [SMILES: COc1ccc(C(c2ccccc2)(c2ccccc2)P2(=O)Oc3ccccc3-c3ccccc32)cc1 ; COc1ccc(C(c2ccccc2)(c2ccccc2)P(=O)(c2ccccc2)c2ccccc2)cc1 ; COc1ccc(C(c2ccccc2)(c2ccccc2)N(c2ccccc2)c2ccccc2)cc1 ; COc1ccc(C(c2ccccc2)(c2ccccc2)n2c3ccccc3c3ccccc32)cc1]

For example, when the protecting group Y is a 4,4′-dimethoxytrityl group, the organic compound of the present embodiment is as follows (provided that, compounds (3-2) to (3-4) other than compound (3-1) are reference compounds.):

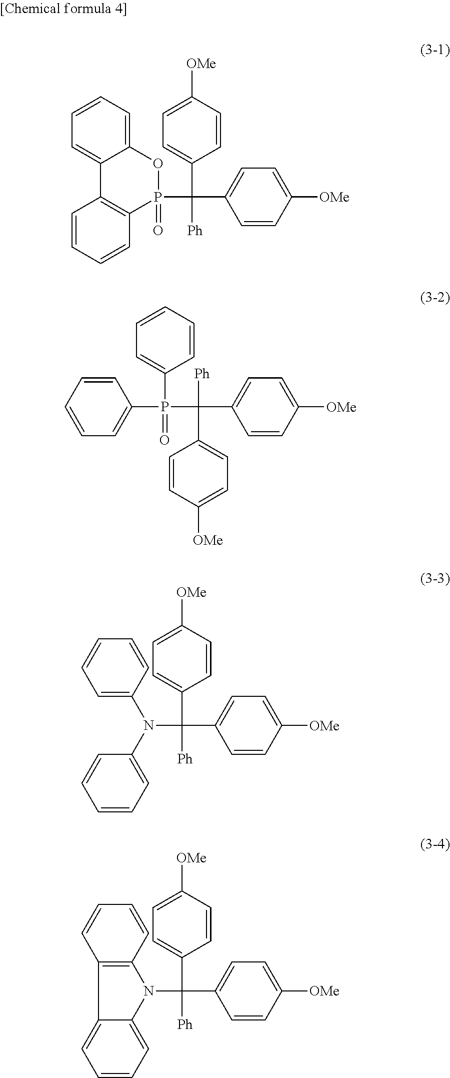 [SMILES: COc1ccc(C(c2ccccc2)(c2ccc(OC)cc2)P2(=O)Oc3ccccc3-c3ccccc32)cc1 ; COc1ccc(C(c2ccccc2)(c2ccc(OC)cc2)P(=O)(c2ccccc2)c2ccccc2)cc1 ; COc1ccc(C(c2ccccc2)(c2ccc(OC)cc2)N(c2ccccc2)c2ccccc2)cc1 ; COc1ccc(C(c2ccccc2)(c2ccc(OC)cc2)n2c3ccccc3c3ccccc32)cc1]

Furthermore, when the protecting group Y is a 4,4′,4″-tris(benzoyloxy)trityl group, the organic compound of the present embodiment is as follows (provided that, compounds (4-2) to (4-4) other than compound (4-1) are reference compounds.):

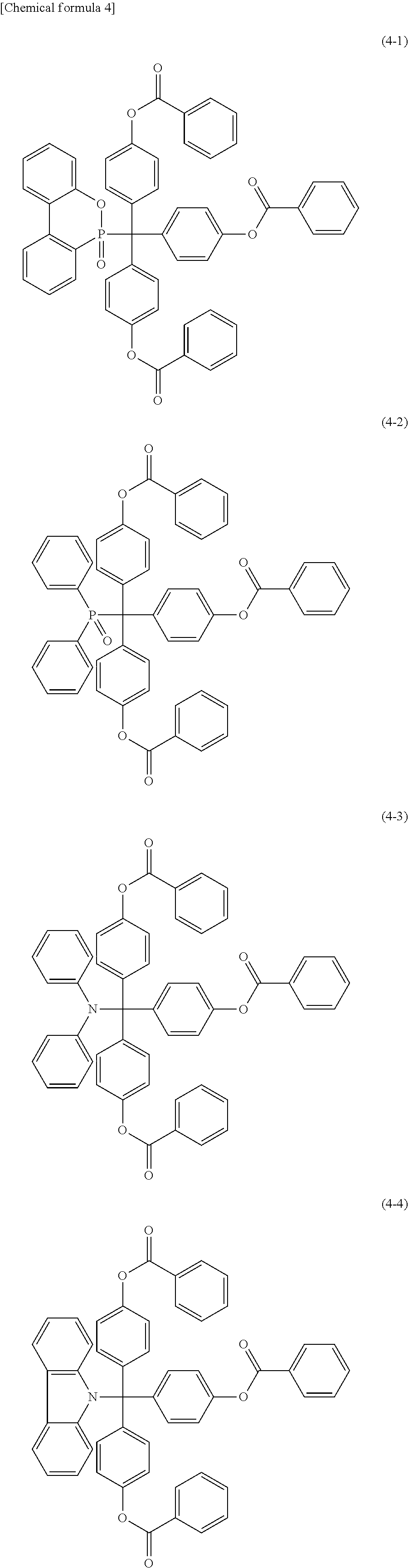 [SMILES: O=C(Oc1ccc(C(c2ccc(OC(=O)c3ccccc3)cc2)(c2ccc(OC(=O)c3ccccc3)cc2)P2(=O)Oc3ccccc3-c3ccccc32)cc1)c1ccccc1 ; O=C(Oc1ccc(C(c2ccc(OC(=O)c3ccccc3)cc2)(c2ccc(OC(=O)c3ccccc3)cc2)P(=O)(c2ccccc2)c2ccccc2)cc1)c1ccccc1 ; O=C(Oc1ccc(C(c2ccc(OC(=O)c3ccccc3)cc2)(c2ccc(OC(=O)c3ccccc3)cc2)N(c2ccccc2)c2ccccc2)cc1)c1ccccc1 ; O=C(Oc1ccc(C(c2ccc(OC(=O)c3ccccc3)cc2)(c2ccc(OC(=O)c3ccccc3)cc2)n2c3ccccc3c3ccccc32)cc1)c1ccccc1]

In addition, it is generally known that the decomposition temperature of a compound that is easily homogeneously cleaved, such as an organic peroxide, is low, and it is inappropriate to add the compound as a flame retardant to various synthetic resins. On the other hand, in the case of the organic compound of the present embodiment, the decomposition temperature at which stable radicals are generated can be set to 200° C. or higher, which is very suitable for use as a flame retardant.

Further, 2,3-dimethyl-2,3-diphenylbutane used in the techniques described in Patent Document 1 and Patent Document 2 described above has a fire extinguishing action caused by two cumyl radicals generated by uniform cleavage during combustion. However, since the molecular weight is as small as less than 250, most of the mixture is volatilized when added to and mixed with a synthetic resin at a high temperature, which not only deteriorates the working environment but also adversely affects the flame retardant effect. In contrast, in the case of the organic compound of the present embodiment, the molecular weight can be designed to be 250 or more, and there is also an advantage that volatility can be suppressed and the addition effect can be sufficiently exhibited even when the organic compound is added to and mixed with the synthetic resin at a high temperature. Therefore, the organic compound of the present embodiment preferably has a weight average molecular weight of 250 or more, more preferably 300 or more, and still more preferably 400 or more. The upper limit of the molecular weight is not particularly limited, but is preferably 1000 or less, and more preferably 900 or less from the viewpoint of the number of radical sources per molecular weight.

### Synthesis Method of Organic Compound

The method for synthesizing the organic compound of the present embodiment is not particularly limited, but for example, the compound X (9,10-dihydro-9-oxa-10-phosphaphenanthrene-10-yl-10-oxide) and a protective reagent having a group that specifically reacts with a functional group of the compound X undergo a condensation reaction in the presence or absence of a base, whereby the organic compound represented by the formula (1) of the present embodiment can be obtained. Specific examples of the protective reagent that can be used include: 4-methoxytrityl chloride, 4,4′-dimethoxytrityl chloride, and 4,4′,4″-tris(benzoyloxy)trityl bromide.

### <Flame Retardant>

The organic compound of the present embodiment is excellent in thermal stability and flame retardancy, and thus can be suitably used, for example, as a flame retardant of a resin composition or the like. That is, the present invention also includes a flame retardant composed of the above-described organic compound.

Since the flame retardant of the present embodiment contains the organic compound described above, the flame retardant exhibits a flame retardant effect when X and Y in the formula (1) are cleaved to generate radicals.

The resin to which the flame retardant of the present embodiment can be applied is not particularly limited, and can be applied to a wide range of resins. That is, the flame retardant of the present embodiment can be applied to both the thermosetting resin and/or the thermoplastic resin. For example, in the case of a thermosetting resin, an epoxy resin, a low molecular weight polyphenylene ether resin, a cyanate ester resin, a phenol resin, benzoxazine, an acid anhydride, a resin having an unsaturated group (acrylic, methacrylic, allyl, styryl, butadiene, maleimide, and the like), or the like can be used alone or as a copolymer. Examples of the thermoplastic resin include a polyphenylene ether resin, a polyphenylene sulfide resin, a liquid crystal polymer, a polyethylene resin, a polystyrene resin, a polyurethane resin, a polypropylene resin, an ABS resin, an acrylic resin, a polyethylene terephthalate resin, a polycarbonate resin, a polyacetal resin, a polyimide resin, a polyamideimide resin, a polytetrafluoroethylene resin, a cycloolefin polymer, a cycloolefin copolymer, and a styrenic elastomer. The resins may be used singly, or two or more thereof may be used in combination.

Among them, application to particularly flammable resins and non-charring resins is effective, and the effect of the flame retardant of the present embodiment can be further exhibited.

When the organic compound of the present embodiment is added as a flame retardant to a resin composition containing the resin as described above, the addition amount thereof is usually 0.5% by mass to 100% by mass, more preferably 1% by mass to 80% by mass with respect to 100% by mass of the resin.

When the added amount of the flame retardant is 0.5% by mass or more, it is considered that a sufficient flame retardant effect can be obtained. In contrast, the content being more than 100% by mass is not preferable because it is not only not very effective, but also it may adversely affect the properties of the resin composition.

Since the resin composition containing the organic compound of the present embodiment as a flame retardant has high thermal stability and flame retardancy, it can be suitably used as various electronic materials such as a prepreg, a metal-clad laminate, a metal foil provided with resin, and an insulating layer of a wiring board (circuit board).

Hereinafter, the present invention will be described more specifically with reference to Examples, but the scope of the present invention is not limited thereto.

### EXAMPLES

Physical properties in the following synthesis examples were measured by the following methods.

### (Nmr Analysis)

1H-NMR analysis was performed using an AVANCE NEO cryo-500 type nuclear magnetic resonance apparatus manufactured by Bruker Biospin, using DMSO-d6 as a solvent for dissolving the sample.

### (Mass Spectrometry)

JMS-T100GC AccuTOF GC manufactured by JEOL Ltd. was used as an apparatus, field desorption (FD) was used as an ionization source, DMSO was used as a solvent for dissolving a sample, and analysis was performed according to a predetermined protocol.

### (Ir Analysis)

Analysis was performed according to a predetermined protocol, in which a Fourier transform infrared spectrophotometer IRAffinity-1 manufactured by Shimadzu Corporation was used as an apparatus, and a single reflection water-flat total reflection absorption measuring apparatus MIRacleA (ZnSe) manufactured by PIKE technologies was used as a prism.

### Synthesis of Organic Compound

### Production Example 1

### Production of 9,10-Dihydro-9-Oxa-10-Phosphaphenanthrene-10-Trityl-10-Oxide (Organic Compound 1)

Into a 300 ml inner volume four-necked flask of hard glass equipped with a stirrer, a thermometer, a reflux condenser, and a gas inlet port were charged 21.6 g (Mw: 216.2×0.1 mol) of 9,10-dihydro-9-oxa-10-phosphaphenanthrene-10-oxide and 183 g of acetonitrile.

While blowing nitrogen gas from the gas inlet port, the temperature was raised, and at the time when the temperature raised up to 70° C., trityl chloride was started to be added portionwise. After 9.3 g of the first portion of trityl chloride had been added, thereafter an operation of adding 9.3 g of trityl chloride was repeated per hour, and a total amount of 27.9 g (Mw: 278.8×0.1 mol) of trityl chloride was added portionwise.

After the portionwise addition had been completed, the temperature of the reactor was set to 80° C., the mixture underwent dehydrochlorination aging reaction for 24 hours, and then cooling was started. At the time when the reactor temperature went down to about 25° C., the precipitated crystals were filtrated under reduced pressure, and then the filtrated crystals were washed with purified water, and the washing operation was continued until the filtrate showed almost neutral pH, followed by drying.

Through the above operations, 44.4 g of white crystal of organic compound 1 (Mw 458.5) having a melting point of about 250° C. was obtained.

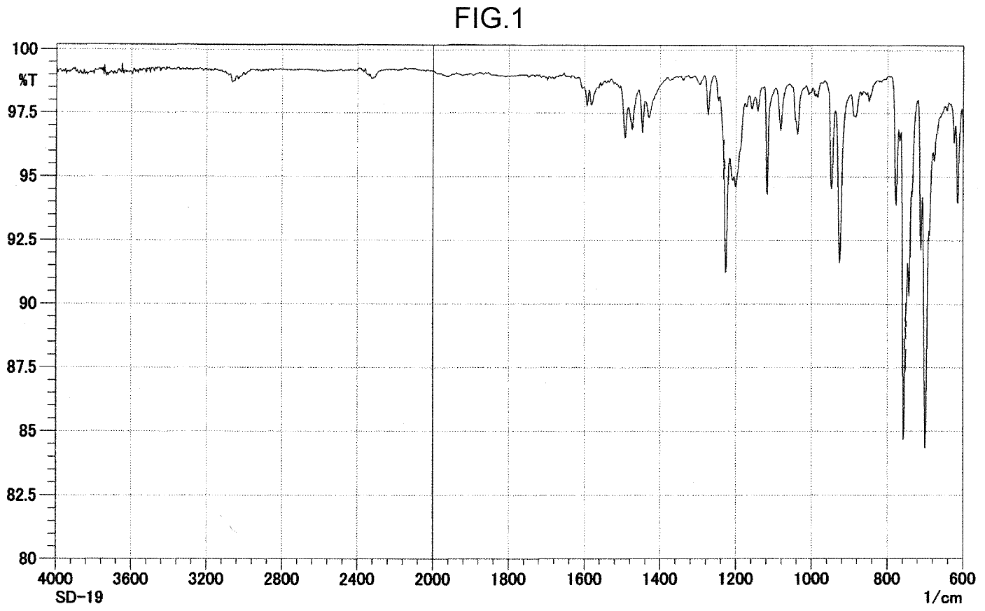

This organic compound 1 was confirmed to have a purity of 99% by liquid chromatographic (LC) analysis, and its infrared (IR) absorption spectrum, 1H-NMR, and FD-MS were as shown in FIGS. 1,2 and 3, respectively, whereby the obtained organic compound 1 was confirmed to be a compound having the following chemical structure.

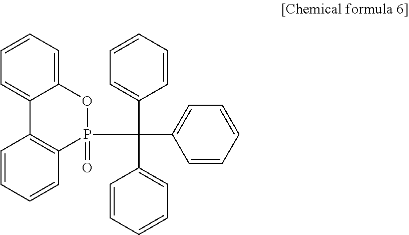 [SMILES: O=P1(C(c2ccccc2)(c2ccccc2)c2ccccc2)Oc2ccccc2-c2ccccc21]

### Reference Example 2

### Production of Trityldiphenylphosphine Oxide (Organic Compound 2)

Into a 500 ml inner volume four-necked flask of hard glass equipped with a stirrer, a thermometer, a reflux condenser, and a gas inlet port were charged 25 g (Mw: 202.2×0.124 mol) of diphenylphosphine oxide and 220 g of acetonitrile.

While blowing nitrogen gas from the gas inlet port, the temperature was raised, and at the time when the temperature raised up to 70° C., trityl chloride was started to be added portionwise. After 11.5 g of the first portion of trityl chloride had been added, thereafter an adding operation of 11.5 g of trityl chloride was repeated per hour, and a total of 34.5 g (Mw: 278.8×0.124 mol) of trityl chloride was added portionwise.

After the portionwise addition had been completed, the temperature of the reactor was set to 80° C., the mixture underwent dehydrochlorination aging reaction for 24 hours, and then cooling down and slow cooling was started. At the time when the reactor temperature went down to around 25° C., the precipitated crystals were filtrated under reduced pressure, and then the filtrated crystals were washed with purified water, and the washing operation was continued until the filtrate showed almost neutral pH, followed by drying.

Through the above operations, 45 g of white crystal of the organic compound 2 (Mw: 444.5) having a melting point of 237° C. was obtained.

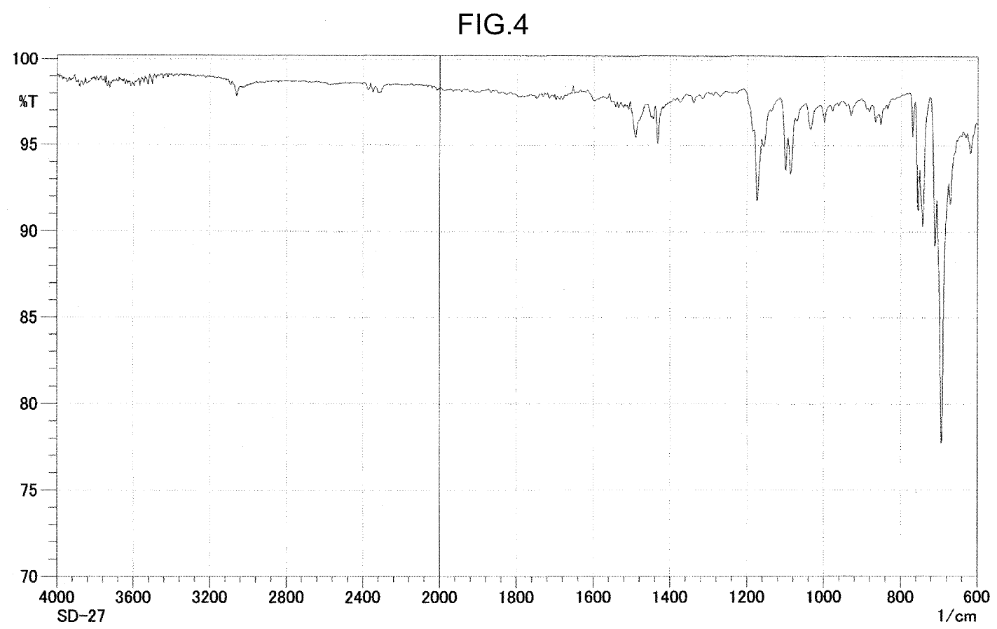

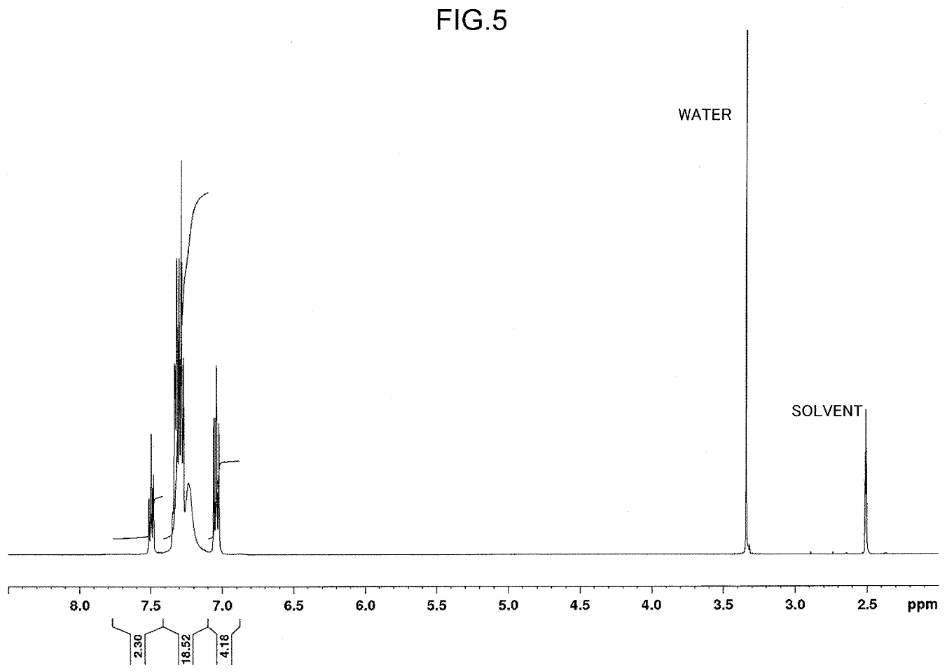

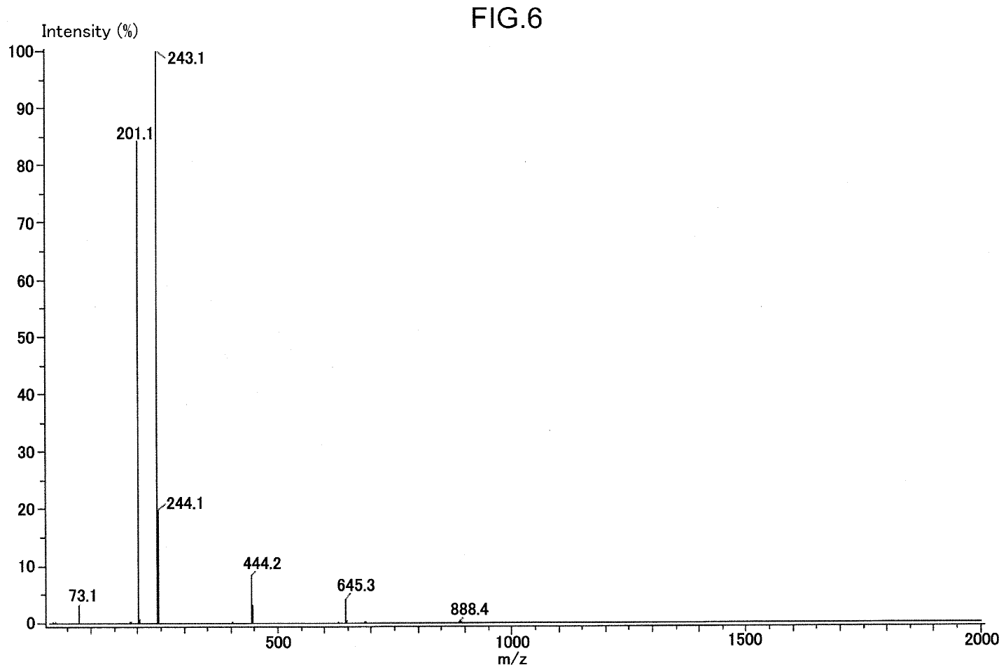

The purity of the organic compound 2 was confirmed to be 99% by liquid chromatographic (LC) analysis, and its infrared (IR) absorption spectrum, 1H-NMR, and FD-MS were as shown in FIGS. 4, 5, and 6, respectively, whereby the obtained organic compound 2 was confirmed to be a compound having the following chemical structure.

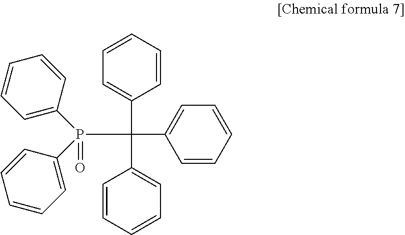 [SMILES: O=P(c1ccccc1)(c1ccccc1)C(c1ccccc1)(c1ccccc1)c1ccccc1]

### Production Example 3

### Production of 9,10-Dihydro-9-Oxa-10-Phosphaphenanthrene-10-(4-Methoxytrityl)-10-Oxide (Organic Compound 3)

Into a 500 ml inner volume four-necked flask of hard glass equipped with a stirrer, a thermometer, a reflux condenser, and a gas inlet port were charged 26.8 g (Mw: 216.2×0.124 mol) of 9,10-dihydro-9-oxa-10-phosphaphenanthrene-10-oxide and 181.6 g of acetonitrile.

The temperature in the flask was raised while blowing nitrogen gas thereinto from the gas inlet port, and at the when the temperature raised up to 50° C., portionwise addition of 4-methoxytrityl chloride was started.

After 12.8 g of the first portion of 4-methoxytrityl chloride had been added, thereafter, an operation of adding 12.8 g of 4-methoxytrityl chloride was repeated per hour, and a total of 38.4 g (Mw: 308.8×0.124 mol) of 4-methoxytrityl chloride was added portionwise.

After the portionwise addition had been completed, the mixture underwent dehydrochlorination aging reaction for 24 hours, and 181.6 g of purified water was added and then cooling down and slow cooling was started. At the time when the reactor temperature went down to around 25° C., the precipitated crystals were filtrated under reduced pressure, and then the filtrated crystals were washed with purified water, and the washing operation was continued until the filtrate showed almost neutral pH, followed by drying.

Through the above operations, 54.6 g of white crystal of the organic compound 3 (Mw: 488.5) having a melting point of 132° C. was obtained.

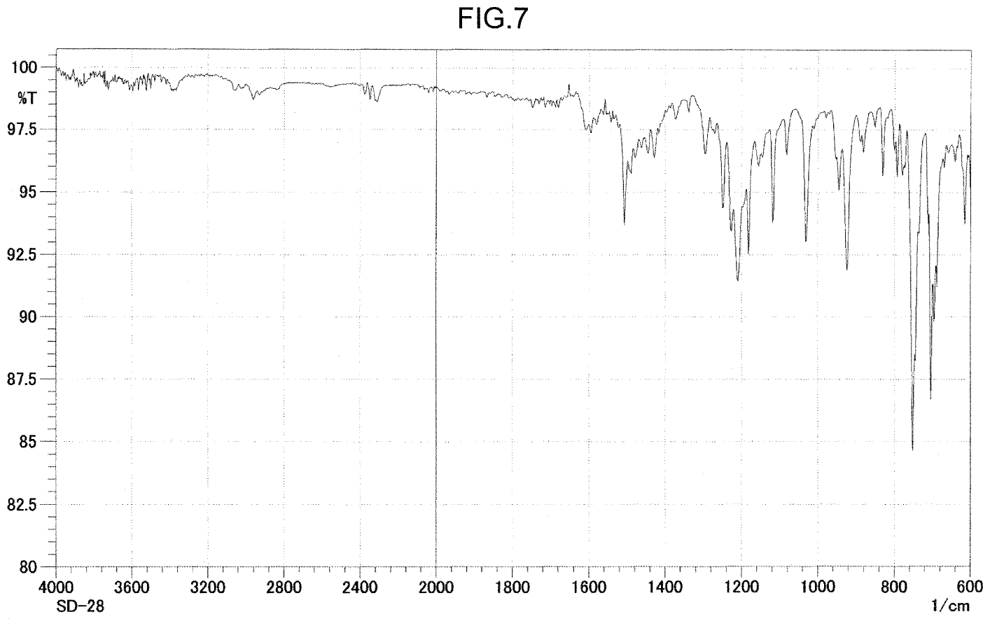

The purity of the organic compound 3 was confirmed to be 99% by liquid chromatographic (LC) analysis, the infrared absorption spectrum (IR) thereof was as shown in FIG. 7, and the resultant organic compound 3 was confirmed to be a compound having the following chemical structure.

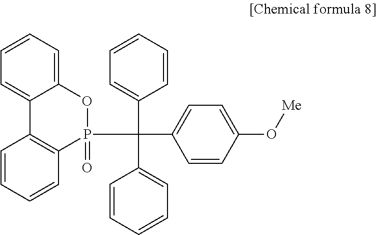 [SMILES: COc1ccc(C(c2ccccc2)(c2ccccc2)P2(=O)Oc3ccccc3-c3ccccc32)cc1]

### Reference Example 4

### Production of 9-tritylcarbazole (Organic Compound 4)

Into a 500 ml inner volume four-necked flask of hard glass equipped with a stirrer, a thermometer, and a reflux condenser were charged 20.9 g (Mw: 167.2×0.125 mol) of carbazole, 17.3 g (Mw: 138.2×0.125 mol) of potassium carbonate, and 256 g of n,n-dimethylformamide.

After charging, heating was started, and at the time when the temperature in the flask raised up to 40° C., portionwise addition of trityl chloride was started. After 1.8 g of the first portion of trityl chloride had been added, an operation of adding 3 g of trityl chloride was repeated about every 10 minutes, and a total amount of 34.8 g (Mw: 278.8×0.125 mol) was used.

After the portionwise addition had been completed, the temperature of the reactor was set to 80° C., the mixture underwent aging for 2 hours, 110 g of purified water was added, and then cooling down and slow cooling was started. At the time when the reactor temperature went down to around 25° C., the precipitated crystals were filtrated under reduced pressure, and then the filtrated crystals were washed with purified water, and the washing operation was continued until the filtrate showed almost neutral pH, followed by drying.

Through the above operations, 41 g of white crystal of the organic compound 4 (Mw: 409.5) having a melting point of 257° C. was obtained.

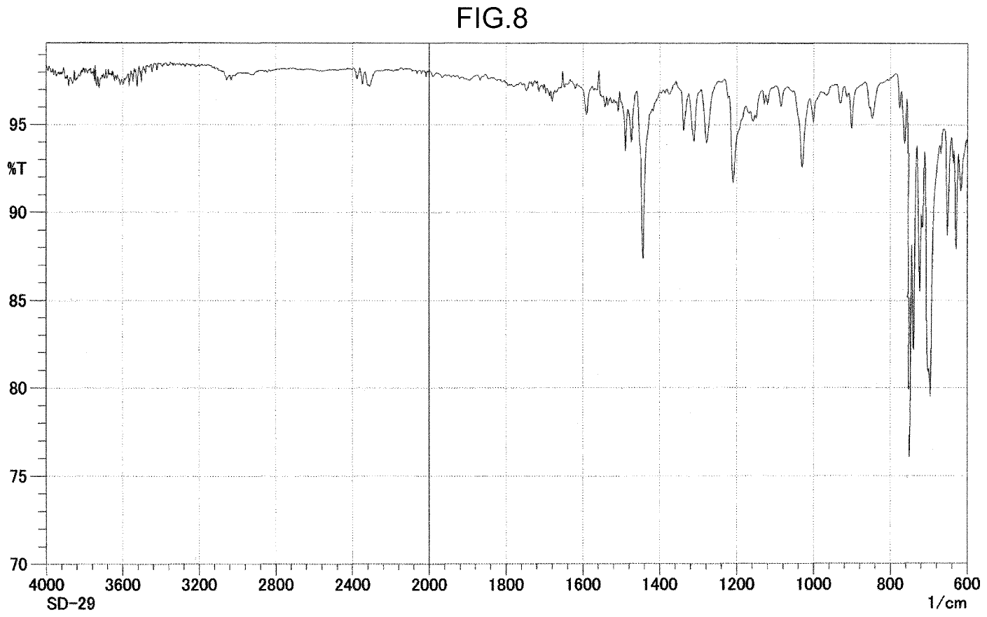

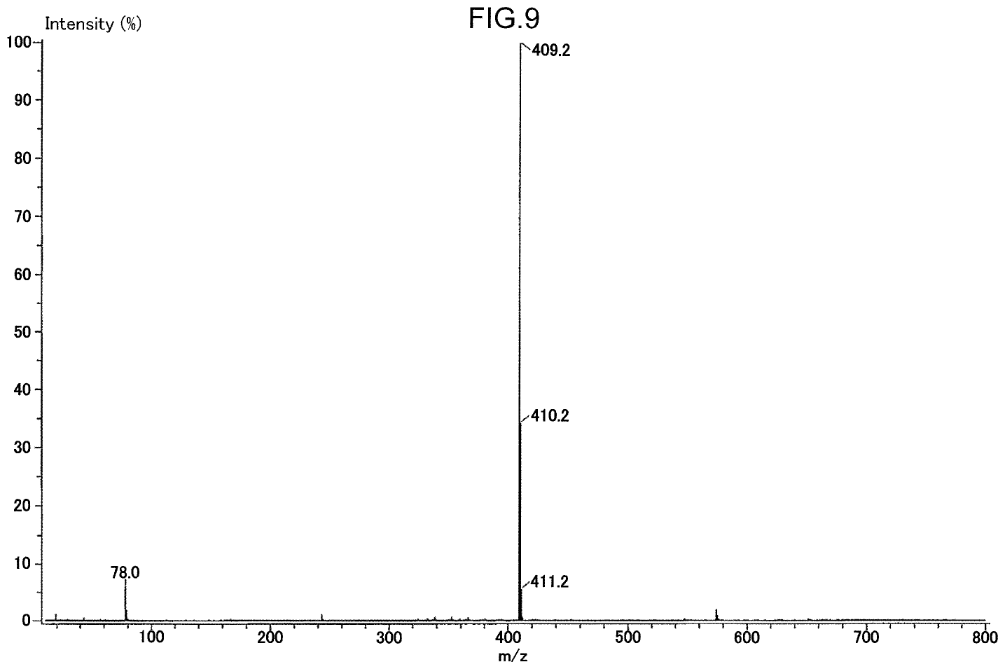

The purity of the organic compound 4 was confirmed to be 99% by liquid chromatographic (LC) analysis, and its infrared absorption spectrum (IR) and FD-MS were as shown in FIGS. 8 and 9, whereby the resultant organic compound 4 was confirmed to be a compound having the following chemical structure.

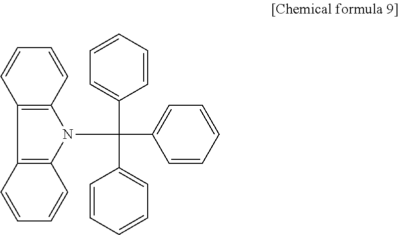 [SMILES: c1ccc(C(c2ccccc2)(c2ccccc2)n2c3ccccc3c3ccccc32)cc1]

### Production Example 5

### Production of 9,10-Dihydro-9-Oxa-10-Phosphaphenanthrene-10-[4,4′,4″-Tris(Benzoyloxy)]-10-Oxide (Organic Compound 5)

Into a 300 ml inner volume four-necked flask of hard glass equipped with a stirrer, a thermometer, a reflux condenser, and a gas inlet port were charged 7.9 g (Mw: 216.2×0.0366 mol) of 9,10-dihydro-9-oxa-10-phosphaphenanthrene-10-oxide and 120 g of acetonitrile.

The temperature in the flask was raised while blowing nitrogen gas thereinto from the gas inlet port, and at the time when the temperature raised up to 70° C., portionwise addition of 4,4′,4″-tris(benzoyloxy)trityl bromide was started. After 5.0 g of the first portion of 4,4′,4″-tris(benzoyloxy)trityl bromide had been added, thereafter an operation of adding 5.0 g thereof was repeated every hour, and a total amount of 25.0 g (Mw 683.6×0.0366 mol) of 4,4′,4″-tris(benzoyloxy)trityl bromide was added portionwise.

After the portionwise addition had been completed, the temperature of the reactor was set to 80° C., the mixture underwent dehydrochlorination aging reaction for 24 hours, and then cooling was started. At the time when the reactor temperature went down to about 25° C., the precipitated crystals were filtrated under reduced pressure, and then the filtrated crystals were washed with purified water, and the washing operation was continued until the filtrate showed almost neutral pH, followed by drying.

Through the above operations, 28.4 g of white crystal of the organic compound 1 (Mw 818.8) having a melting point of about 233° C. was obtained.

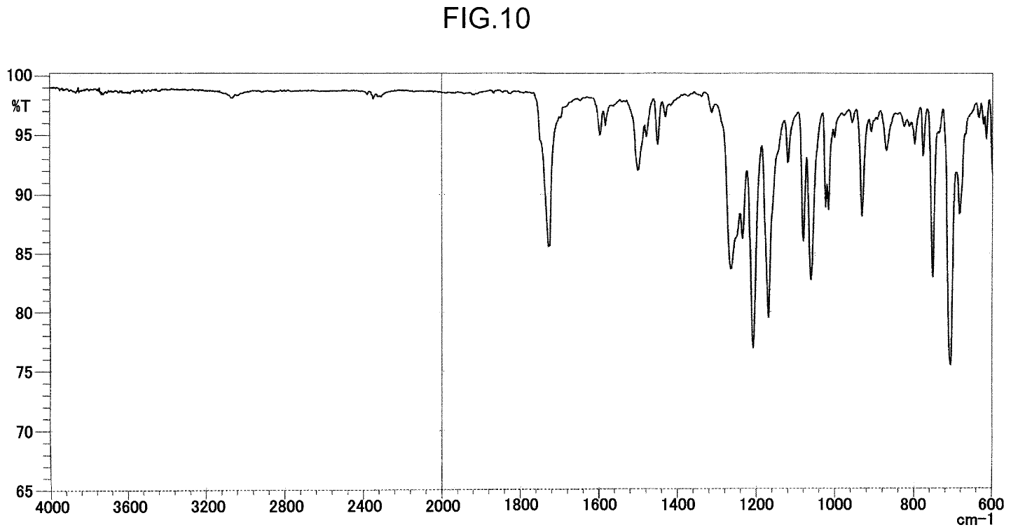

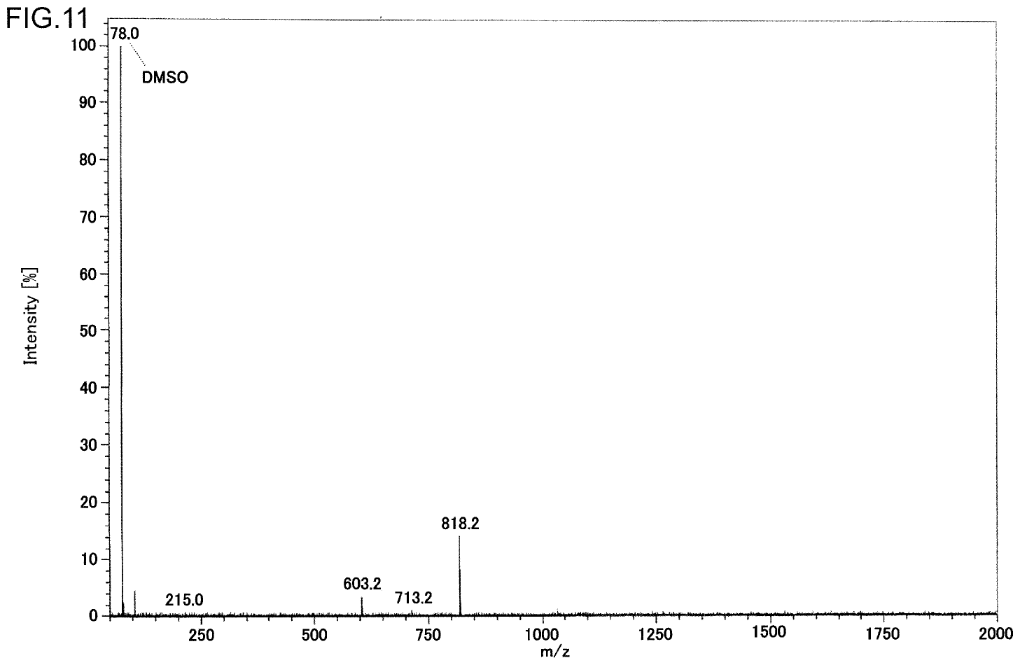

This organic compound 5 was confirmed to have a purity of 99% by liquid chromatographic (LC) analysis, its infrared absorption spectrum (IR) and FD-MS were as shown in FIGS. 10 and 11, respectively, whereby the resultant organic compound 5 was confirmed to be a compound having the following chemical structure.

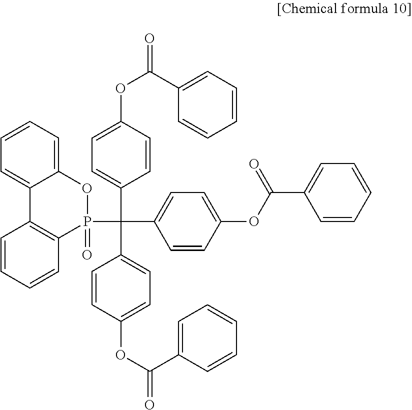 [SMILES: O=C(Oc1ccc(C(c2ccc(OC(=O)c3ccccc3)cc2)(c2ccc(OC(=O)c3ccccc3)cc2)P2(=O)Oc3ccccc3-c3ccccc32)cc1)c1ccccc1]

### Evaluation Test 1

### Example 1

Into toluene was added 100 parts by mass of a styrenic elastomer resin (“Septon V9827 (product name)”, manufactured by Kuraray Co., Ltd.) and the mixture was stirred for 60 minutes so that the resin was completely dissolved, followed by addition of 79 parts by mass of the organic compound 1 obtained in Production Example 1 as a flame retardant, and then the mixture was stirred for 60 minutes to afford a varnish resin composition (resin varnish).

### Comparative Example 1

A varnish resin composition (resin varnish) was obtained in the same manner as in Example 1, except that in place of the organic compound 1, 9,10-dihydro-10-(2,5-dihydroxyphenyl)-9-oxa-10-phosphaphenanthrene-10-oxide (HCA): (manufactured by SANKO Co., Ltd.) having the following chemical structure was used as a flame retardant, and its addition amount was adjusted to 26 parts by mass so the phosphorus content as to be the same as in Example 1.

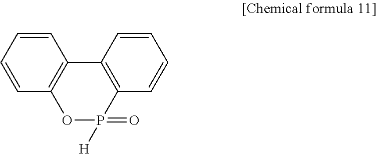 [SMILES: O=[PH]1Oc2ccccc2-c2ccccc21]

### Comparative Example 2

A varnish-like resin composition (resin varnish) was obtained in the same manner as in Example 1, except that, in place of the organic compound 1, 2,3-diphenyl-2,3-dimethylbutane (“Nofmer BC-90 (product name)”, manufactured by NOF CORPORATION) having the following chemical structure was used as a flame retardant, and its addition amount was adjusted to 40 parts by mass so the radical concentration at the time of radical cleavage as to be the same as in Example 1.

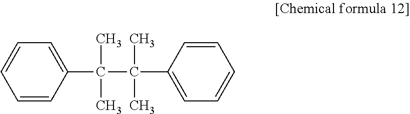 [SMILES: CC(C)(c1ccccc1)C(C)(C)c1ccccc1]

### Comparative Example 3

A varnish resin composition (resin varnish) was obtained in the same manner as in Example 1 except that as a flame retardant, an aromatic condensed phosphoric acid ester (“PX-200 (product name)”, manufactured by DAIHACHI CHEMICAL INDUSTRY CO., LTD.) having the following chemical structure was used in place of the organic compound 1, and its addition amount was adjusted to 50 parts by mass so the phosphorus content as to be the same as in Example 1.

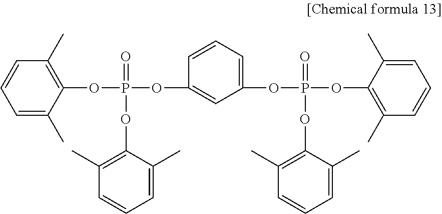 [SMILES: Cc1cccc(C)c1OP(=O)(Oc1cccc(OP(=O)(Oc2c(C)cccc2C)Oc2c(C)cccc2C)c1)Oc1c(C)cccc1C]

### Evaluation Sample

A film provided with resin was prepared using the resin varnish obtained in Example 1 and Comparative Examples 1 to 4. As a base material, PET film (“SP-PETO1” manufactured by Mitsui Chemicals Tohcello, Inc.) was used. The resin varnish was applied to the surface of the base material so as to have a thickness of 100 μm after drying, and this coating was dried by heating at 120 to 160° C. for about 2 to 5 minutes to give a film provided with resin. Thereafter, the base material was peeled off from the resultant film provided with resin, and four sheets were piled up, then sandwiched and stacked between copper foils each having a thickness of 18 m, followed by heating and pressurization at a temperature of 200° C. and a pressure of 2 MPa for 2 hours to form a copper-clad substrate with an insulating layer thickness of 400 m, and the resultant copper-clad substrate was etched to remove the copper foils, so that an evaluation substrate was obtained.

### Evaluation Method

### (Flame Retardancy)

Using the evaluation substrate obtained above, its flammability was evaluated in accordance with the flammability test of UL 94. However, the evaluation substrate is exposed to a test flame only once since the evaluation substrate may be dripped. The evaluation criteria are as follows.
Complete combustion: The flame rises from the lower end at which the test flame is applied to the chucked upper end of the evaluation substrate, and the evaluation substrate is in a combustion state.
Flame extinction: The flame does not rise from the lower end at which the test flame is applied to the chucked upper end of the evaluation substrate, and the flame is extinguished within 5 seconds after once application of the test flame for 10 seconds.

### (Thermogravimetric Measurement)

The obtained evaluation substrate was subjected to thermogravimetric measurement in a nitrogen atmosphere in accordance with the method of IPC TM-650 2.4.24.1, and the temperature at the time when the weight loss reached 5% was evaluated.

The above results are summarized in Table 1.

TABLE 1

| | | Comparative | Comparative | Comparative |
|---|---|---|---|---|
| | Example 1 | Example 1 | Example 2 | Example 3 |
| Septon V9827 | 100 | 100 | 100 | 100 |
| Organic compound 1 | 79 | | | |
| HCA | | 26 | | |
| Nofmer BC-90 | | | 40 | |
| PX-200 | | | | 50 |
| Phosphorus content | 3% | 3% | 0% | 3% |
| Radical concentration | 0.34 | — | 0.34 | |
| at cleavage | | | | |
| Flame retardancy | Flame | Flame | Complete | Not able to |
| | extinction | extinction | combustion | produce samples |
| Thermogravimetric | 331° C. | 254° C. | 301° C. | Not able to |
| measurement | | | | produce samples |

### Discussion

As a result, in Example 1, the flame retardancy was good, and the thermal stability was very high. In Comparative Example 1, the flame retardancy was good, but the thermal stability was lower than that in Example 1, and in Comparative Example 2, the flame retardancy was not good. Note that, in Comparative Example 3, when the film provided with resin was heated and pressurized, the flow and tackiness of the resin were very large, and the shape of the evaluation substrate was not able to be maintained.

As is apparent from the above results, it was confirmed that the laminate using the organic compound of the present invention as a flame retardant can achieve both excellent flame retardancy and heat resistance as compared with the laminate of Comparative Example using a conventionally used phosphorus-based flame retardant or 2,3-diphenyl-2,3-dimethylbutane having a fire extinguishing action caused by radicals.

### Evaluation Test 2

### Example 2

Into toluene (solvent) were added 70 parts by mass of a modified polyphenylene ether resin (“SA 9000 (product name)”, manufactured by SABIC Innovative Plastics), 30 parts by mass of a curing agent (“TAlC”, triallyl isocyanurate (manufactured by Nippon Kasei Chemical Co., Ltd.)), and 2 parts by mass of a reaction initiator (“Perbutyl P”, 1,3-bis(butylperoxyisopropyl) benzene (manufactured by NOF CORPORATION)) and sufficiently dissolved. Thereafter, 42.5 parts by mass of the organic compound 1 obtained in Production Example 1 above was added as a flame retardant, and then 100 parts by mass of an inorganic filler (“SC2300-SVJ” Vinylsilane-treated spherical silica (manufactured by Admatechs Company Limited)) was added, and then the mixture was stirred for 60 minutes. Thereafter, dispersion was performed with a bead mill. By doing so, a varnish-like resin composition (varnish) was obtained.

### Comparative Example 4

Except that a flame retardant was not added, the same procedure as in Example 2 was carried out to obtain a varnish-like resin composition (resin varnish).

### Comparative Example 5

A varnish-like resin composition (resin varnish) was obtained in the same manner as in Example 2 except that 9,10-dihydro-10-(2,5-dihydroxyphenyl)-9-oxa-10-phosphaphenanthrene-10-oxide (HCA) having the above chemical structure was used as a flame retardant instead of the organic compound 1, and 16.5 parts by mass was added so that the phosphorus content was the same as in Example 2.

### Comparative Example 6

A varnish-like resin composition (resin varnish) was obtained in the same manner as in Example 2 except that 2,3-diphenyl-2,3-dimethylbutane (“Nofmer BC-90 (product name)”, manufactured by NOF CORPORATION) having the above chemical structure was used as a flame retardant in place of the organic compound 1, and 23 parts by mass of 2,3-diphenyl was added so that the radical concentration at the time of radical cleavage was the same as in Example 2.

### Comparative Example 7

A varnish-like resin composition (resin varnish) was obtained in the same manner as in Example 2 except that an aromatic condensed phosphate (“PX-200 (product name)”, manufactured by DAIHACHI CHEMICAL INDUSTRY CO., LTD.) having the above chemical structure was used as a flame retardant in place of the organic compound 1, and 29.2 parts by mass of the aromatic condensed phosphate was added so that the phosphorus content was the same as in Example 2.

### Comparative Example 8

A varnish-like resin composition (resin varnish) was obtained in the same manner as in Example 2 except that an aromatic condensed phosphate (“PX-200 (product name)”, manufactured by DAIHACHI CHEMICAL INDUSTRY CO., LTD.) having the above chemical structure was used as a flame retardant in place of the organic compound 1, and 15 parts by mass was added so that the phosphorus content was 1.2%.

### Evaluation Sample

A glass base material (#2116 type, “E glass” (manufactured by Nitto Boseki Co., Ltd.) was impregnated with each of the resin varnishes obtained in Example 2 and Comparative Examples 4 to 8, and then heated and dried at 120° C. for about 3 minutes to obtain a prepreg. At that time, the thickness was adjusted to 110 μm. Thereafter, four sheets of the obtained prepregs were stacked and laminated, a copper foil “FV-WS foil 18 μm (manufactured by FURUKAWA ELECTRIC CO., LTD.)” was stacked on both surfaces, and heated and pressed under conditions of a temperature of 200° C., 2 hours, and a pressure of 3 MPa to form a copper-clad substrate for evaluation having a thickness of 440 μm, and the obtained copper-clad substrate was etched to remove the copper foil, thereby obtaining an evaluation substrate.

### Evaluation Method

### (Flame Retardancy)

Using the evaluation substrate obtained above, the combustibility (average seconds) was evaluated in accordance with the combustibility test of UL 94. Specifically, the average seconds until the fire went out was measured in a total of 10 times of flame application in which a test flame was applied twice to five evaluation substrate, and the average value thereof was calculated. As the evaluation criteria, 25 seconds or less was accepted. In the table, “Complete combustion” means a state in which the flame rises from the lower end at which the test flame is applied to the chucked upper end of the evaluation substrate, and the evaluation substrate is in a combustion state.

### (Glass Transition Temperature (Tg))

Using the evaluation substrate, Tg was measured using a viscoelastic spectrometer “DMS 100” manufactured by Seiko Instruments Inc. At this time, dynamic viscoelasticity measurement (DMA) was performed with a tensile module at a frequency of 10 Hz, and Tg was defined as the temperature at which tan 6 showing maximum in a condition when the temperature was raised from room temperature up to 320° C. at a heating rate of 5° C./min. In this test, Tg of 250° C. or higher was evaluated to be accepted.

The above results are summarized in Table 2.

TABLE 2

| | | Comparative | Comparative | Comparative | Comparative | Comparative |
|---|---|---|---|---|---|---|
| | Example 2 | Example 4 | Example 5 | Example 6 | Example 7 | Example 8 |
| SA9000 | 70 | 70 | 70 | 70 | 70 | 70 |
| TAIC | 30 | 30 | 30 | 30 | 30 | 30 |
| PBP | 2 | 2 | 2 | 2 | 2 | 2 |
| SC2300-SVJ | 100 | 100 | 100 | 100 | 100 | 100 |
| Organic compound 1 | 42.5 | | | | | |
| HCA | | | 16.5 | | | |
| Nofmer BC-90 | | | | 23 | | |
| PX-200 | | | | | 29.2 | 15 |
| Phosphorus content | 2% | | 2% | | 2% | 1.2% |
| Radical concentration | 0.19 | | | 0.19 | | |
| at cleavage | | | | | | |
| Flame retardancy | 14 | Complete | 2 | Complete | 2 | 26 |
| (average seconds) | | combustion | | combustion | | |
| Tg | 262 | 271 | 229 | 221 | 200 | 213 |

### Discussion

As is apparent from Table 2, it was confirmed that Example 2 had good flame retardancy and high Tg. On the other hand, in Comparative Examples 4, 6, and 8, sufficient flame retardancy could not be obtained. In Comparative Examples 5 and 7, the flame retardancy was relatively good, but the Tg was considerably lower than that in Example 2.

As is apparent from the above results, it was confirmed that the laminate using the organic compound of the present invention as a flame retardant can achieve both excellent flame retardancy and heat resistance as compared with the laminate of Comparative Example using a conventionally used phosphorus-based flame retardant or 2,3-diphenyl-2,3-dimethylbutane having a fire extinguishing action caused by radicals.

This application is based on Japanese Patent Application No. 2021-81740 filed on May 13, 2021, the contents of which are included in the present application.

In order to express the present invention, the present invention has been described above appropriately and sufficiently through the embodiments with reference to specific examples, drawings and the like. However, it should be recognized by those skilled in the art that changes and/or improvements of the above-described embodiments can be readily made. Accordingly, changes or improvements made by those skilled in the art shall be construed as being included in the scope of the claims unless otherwise the changes or improvements are at the level which departs from the scope of the appended claims.

### INDUSTRIAL APPLICABILITY

The present invention has wide industrial applicability in technical fields such as electronic materials, electronic devices, and optical devices.

1. An organic compound represented by the following formula (1): 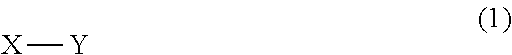
wherein X is 9,10-dihydro-9-oxa-10-phosphaphenanthrene-10-yl-10-oxide and Y is a protecting group.

2. The organic compound according to claim 1, wherein in the formula (1), Y is a protecting group derived from a protective reagent.

3. The organic compound according to claim 1, wherein the protecting group is a group represented by the following formula (2): 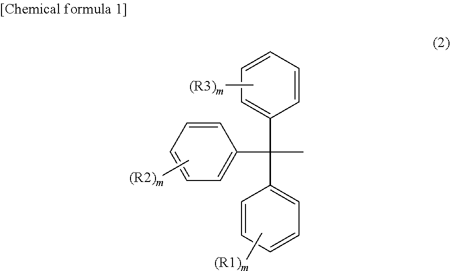
(In the formula, R1, R2, and R3 each independently represent hydrogen, a benzoyloxy group, a vinylbenzyl group, an alkoxy group having 1 to 6 carbon atoms, or an alkenyl group having 2 to 6 carbon atoms, and m each independently represents an integer from 1 to 5).

4. A flame retardant comprising the organic compound according to claim 1.
